(19) United States
(12) Patent Application Publication
(10) Pub. No.: US 2022/0234261 A1
(43) Pub. Date: Jul. 28, 2022

(54) MOULD FOR THE PRODUCTION OF SLABS AND RELATIVE FORMING METHOD

(71) Applicant: MEDICAL SOPARFI S.A, Luxembourg (LU)

(72) Inventor: Raffaella ZAGNI, La Maddalena (IT)

(73) Assignee: MEDICAL SOPARFI S.A, Luxembourg (LU)

(21) Appl. No.: 17/617,623

(22) PCT Filed: Jun. 14, 2019
(86) PCT No.: PCT/IB2019/054985

§ 371 Date: Dec. 9, 2021

(51) Int. Cl. B29C 43/56; B29C 43/00; B29C 43/36

(52) U.S. Cl. CPC B29C 43/56; B29C 43/003; B29C 2043/503; B29C 2043/563; B29C 43/36

(57) ABSTRACT

A mould for the production of slabs in granular material and/or grits and/or sands with curing resins comprising a flat bottom, a perimeter framework operatively or rigidly connected to the flat bottom wherein the perimeter framework comprises a plurality of side walls, the flat bottom and the perimeter framework delimiting a compartment for forming the slab; a plant for the production and a method of forming slabs in granular material and/or grits and/or sands with curing resins are also provided.

### TECHNICAL FIELD OF THE INVENTION

The present invention relates to a mould for the production of slabs comprising from grits and/or sands of stone material bonded with a curing resin wherein the sheets have a substantially uniform thickness.

More in detail, the aforementioned slabs may comprise granulated material, stones or other substances reduced to small fragments, sands of stone material, quartz, etc., linked to a curing resin when subjected to the action of heat and/or in the presence of a catalyst. The present invention also relates to a production plant and a method for forming such slabs obtained by using the aforesaid mould.

### BACKGROUND ART

The manufacturing of slabs consisting of grits and/or sands of natural stone material and of a binder such as a resin suitable for curing when subjected to the action of heat and/or in the presence of a catalyst is known.

Generally, the method for manufacturing these slabs provides for the production of a dough consisting precisely of a selected size granulated material and synthetic resin, which is deposited in quantities dosed on a conveyor belt which is advanced towards a forming station.

At this station, the dough is subjected to a vibro-compacting action which provides for the application of a vibratory motion of predetermined frequency under vacuum conditions, to remove any air trapped in the dough. Subsequently, the material compacted in this way is brought to a station for curing the resin. Before reaching the forming station, it is known to place a sheet or layer of protective material on the upper surface of the dough deposited on the conveyor belt. In this way it is prevented that the shutter of the pressing means may enter directly into contact with the dough, preserving its cleanliness and avoiding altering the characteristics of the upper portion of the dough. This method, although comprising a reduced number of steps, is not free from drawbacks such as the presence of shrinkages at the perimeter portions of the compacted material or, again, of an excessive over-thickness of the slab obtained at the end of the manufacturing process or of any flatness defects. In all the indicated above cases, subsequent mechanical processes are necessary, which inevitably have a negative impact on the production process, increasing costs.

Moreover, such problems derive from a non-optimal use of raw material, which in reality appears excessive in light of the formation of shrinkages or over-portions to be eliminated. Furthermore, the required mechanical processes determine a consequent consumption of tools for the operations of calibrating the slabs which involve a further increase in production costs.

There is a need in the sector to optimize the means available for the production of such slabs of grits bonded with resins as well as the relative production method.

### OBJECTS OF THE INVENTION

The main object of the present invention is therefore to improve the state of the art relating to the manufacture of manufactured articles in slabs consisting of a granulated material or sands of stone material bonded with a resin and more specifically an improvement of the existing method and equipment.

Within the scope of this aim, an object of the present invention is to provide a mould for the production of slabs of grits bonded with resins suitable for overcoming the above described drawbacks of the prior art.

Another object of the present invention is to provide a mould for the production of slabs of grits bonded with easy-to-implement resins to optimize the productivity of preexisting systems.

A further object of the present invention is to provide a mould for the production of slabs of grits bonded with resins which are easy to actuate and use.

According to an aspect of the present invention, it is provided a mould for the production of slabs of grits bound with resins according to claim 1.

The subject of the present invention is also a plant according to claim 9 and a method according to claim 14 for the production and forming of slabs obtained from grits and/or sands bound with curing resins.

The dependent claims refer to preferred and advantageous embodiments of the invention.

### BRIEF DESCRIPTION OF THE DRAWINGS

Further features and advantages of the present invention will become apparent from the detailed description of a preferred, non-exclusive embodiment of a mould for the production of slabs of grits bound with resins, illustrated by way of non-limiting example, in the appended drawings, wherein:

FIG. 1 is a detailed exploded perspective view of a general version of the mould for the production of slabs according to the present invention;

FIG. 1a is a detailed sectional view of an operative configuration assumed by the mould for the production of slabs according to the present invention;

FIGS. 2-12 are side views of a version of a plant for the production of slabs according to the present invention;

FIGS. 13-24 are side views of another version of a plant for the production of slabs according to the present invention;

FIGS. 25-36 are side views of a further version of a plant for the production of slabs according to the present invention; and

FIGS. 37-49 are side views of yet another version of a plant for the production of slabs according to the present invention.

### EMBODIMENTS OF THE INVENTION

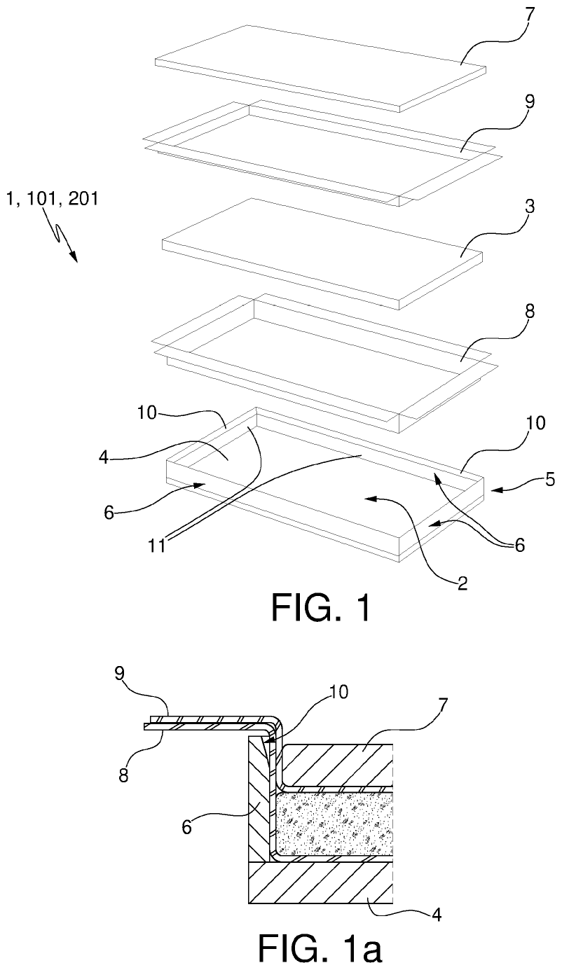

FIG. 1 shows a general version of a mould 1 for the production of slabs of granular material and/or grits and/or sands bound with resins according to the present invention. For the sake of simplicity in the following description, the term grits means granulated material, stones or other substances reduced to small fragments, sands of stone material, quartz, etc., individually and/or in any size and combined together in various proportions.

The mould 1 defines a compartment 2 for a layer of a mixture 3 comprising grits bound with a curing resin to be compacted and subsequently cured in order to form a compact slab of uniform thickness.

Generally, the mould 1 has a bulk in a quadrangular or rectangular plan.

The attached figures show the mould 1 with a rectangular shaped plan, although it is understood that further conformations falling within the same concept of the invention are possible.

The mould 1 comprises a flat bottom 4 and a perimeter framework 5 which laterally delimits the flat bottom 4.

The perimeter framework 5 is operatively connected to the flat bottom 4.

The perimeter framework 5 comprises individual side walls 6.

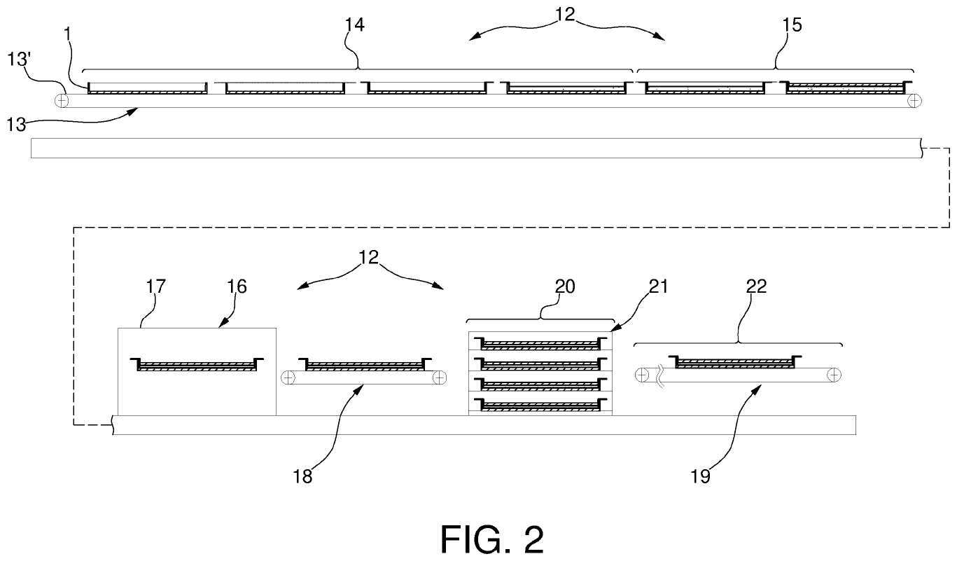

In the version shown in FIGS. 2-12, the mould 1 comprises fixed side walls 6 with respect to the flat bottom 4.

Furthermore, FIG. 2 illustrates the complete operative sequence which is characterized by a step of curing the slabs inside the mould itself.

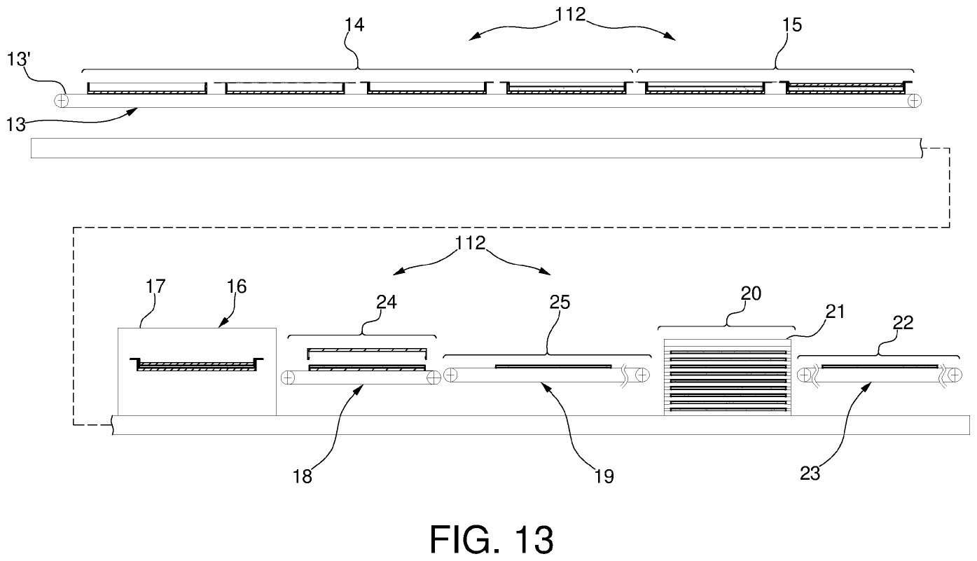

Also in the version illustrated in FIGS. 13-24, the mould 1 comprises side walls 6 fixed with respect to the flat bottom 4, FIG. 13 illustrates the relative complete operating sequence, which is characterized by a step of overturning the mould to extract the slabs from the mould and a step of curing the slabs without mould.

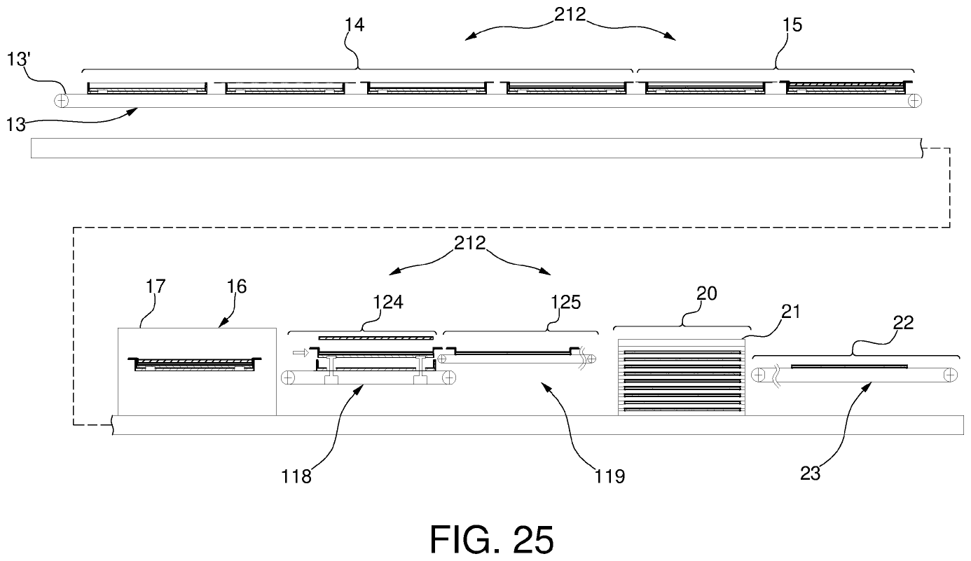

In the version illustrated in FIGS. 25-36, the mould 1 comprises fixed side walls 6 with respect to the flat bottom 4 and an extractor device for the extraction of the slabs from the mould. In the operating sequence illustrated in FIG. 25, it can be seen that, following the extraction of the slab from the mould 1, the curing step takes place without a mould.

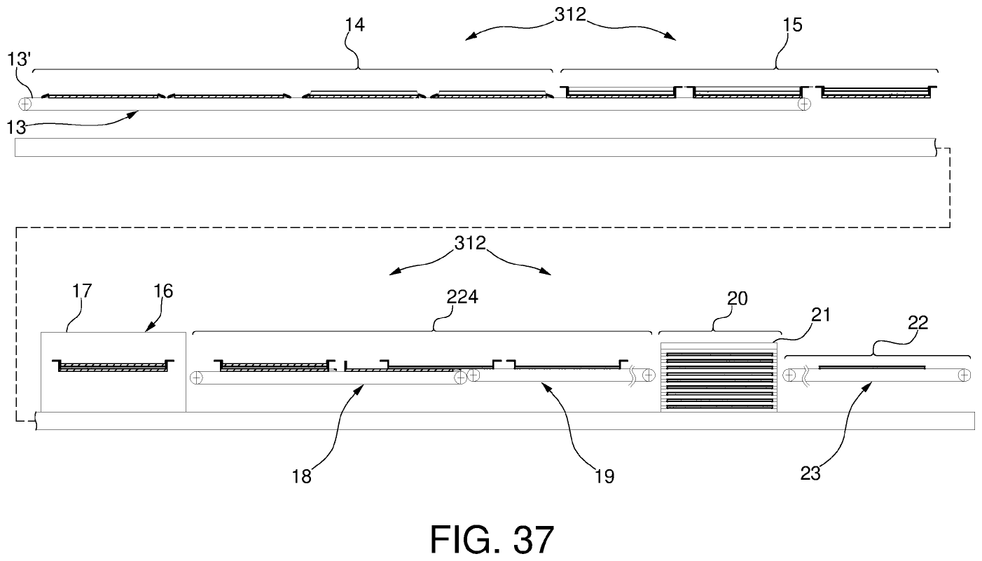

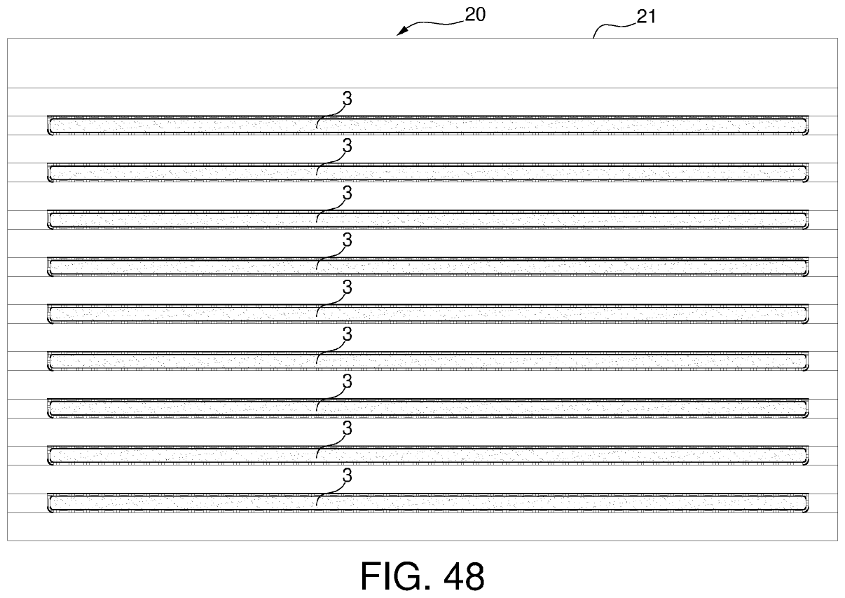

In the version illustrated in FIGS. 37-49, the mould 1 comprises side walls 6, of which at least one wall 6 is tiltable with respect to the flat bottom 4 to allow the extraction of the slab. In the operating sequence illustrated in FIG. 37, it can be seen that the front wall is tilted substantially on the same plane as the bottom 4 to allow the extraction of the slab contained in the mould 1, therefore the subsequent curing step takes place without a mould.

In all the versions, the mould 1 is of the rigid type, meaning that the material with which it is formed has a mechanical rigidity such as not to be subjected to deformations during use that could alter the shape, the flatness or in general the properties of the slab formed inside the mould 1 itself.

The walls that make up the mould 1, i.e. the flat bottom 4 and the side walls 6, have a controlled flatness.

Moreover, the flat bottom 4 and/or the side walls 6 have a controlled roughness to allow the production of slabs with specific surface characteristics.

The mould 1 can comprise a closing element 7 suitable for delimiting above the mould 1 itself. The closing element 7 is shaped as a flat slab.

More in detail, the closing element 7 has a footprint which is complementary to the area delimited between the side walls 6.

Therefore, the closing element 7 can be introduced from above into the compartment 2, delimiting it at the top. The closing element 7 can be configured to be operatively connectable to the upper punch of a vacuum vibro-compaction press of the layer of material contained in the mould 1.

The mould 1 comprises a first protective sheet 8 covering the flat bottom 4 and the inner portion of the perimeter framework 5.

In fact, the first sheet 8 defines a protection element interposed between the layer of the mixture 3 and the bottom 4 and the inner portion of the perimeter framework 5.

Therefore, thanks to the presence of the first sheet 8, the mixture does not come into direct contact with the lower and side walls of the mould 1.

The mould 1 then comprises a second sheet 9 which can be positioned above the mixture 3, which is introduced into the compartment 2.

In use, the second sheet 9 is interposed between the uniform layer of the mixture 3 and the closing element 7.

The second sheet 9, in fact, prevents the layer of the mixture 3 from coming into direct contact with the latter.

The first sheet 8 and the second sheet 9 then define a casing in which the mixture of material to be compacted and cured is contained.

The first sheet 8 and the second sheet 9 can be made of paper or paper-based or of a suitable material able to withstand temperatures between 70° and 180°.

The first 8 and the second protective sheet 9 can be made with one or more materials selected from the group comprising: plain paper, paper with coatings having antiadherent properties, i.e. with silicone coating, polypropylene, etc., simple cardboard, cardboard with coating having anti-adherent properties, plastic films with anti-adherent properties, water-soluble films, etc.

With reference to FIG. 1, an exploded diagram of the mould 1 according to the present invention is shown, comprising a flat bottom 4 and the perimeter framework 5, the first sheet 8, the layer of the mixture 3, the second sheet 9 and the closing element 7.

In FIG. 1, the first sheet 8 and the second sheet 9 are shown shaped as tray elements to improve the intelligibility of the invention, although meaning that the first sheet 8 and the second sheet 9 can be flat and deformed as a result of the insertion in the mould 1 or provided pre-shaped according to the actual shape of the mould 1 without any limitation.

With reference to the detailed view illustrated in the attached FIG. 1a, it can be seen that each of the side walls 6 can present a flaring 10 at the upper end.

More precisely, the flaring 10 can be realized at the inner surface 11, in use, of the side wall 6.

This flaring 10 defines a chute or a guiding and centring element suitable for facilitating the insertion of the first sheet 8, of the second sheet 9 or of the closing element 7 inside the compartment 2.

In particular, the flaring 10 performs its function with the side walls 6 vertically associated with the flat bottom 4.

As mentioned above, in the version shown in FIGS. 2-12, the mould 1 comprises fixed side walls 6 with respect to the flat bottom 4, and the operative sequence is characterized by a step of curing the slabs inside the mould itself.

According to the version of the present invention illustrated in FIGS. 2-12, FIG. 2 schematically illustrates a plant 12 for the production of slabs obtained from grits and/or sands in stone material bonded with resins that can be cured when subjected to heat or to a suitable catalyst according to methods known in the field.

The plant 12 comprises movement means 13, 18, 19 on which at least one mould 1 is arranged, suitable for supporting and moving the latter along the various stations of plant 12 itself. By way of example, the movement means 13, 18, 19 can comprise conveyor belts 13′ (FIGS. 2-12).

However, further movement means 13, 18, 19 are possible, which are configured as a roller conveyor suitable for performing the same purposes, or other equivalent means suitable for supporting and transporting the mould 1 along the various stations of the plant 12 itself. In the upper line of FIG. 2 it is possible to note the first steps of preparation of the mould 1 with the mixture 3, preceding the vibro-compaction step, while in the lower line of FIG. 2 it is possible to note, among other things, the step of vacuum vibro-compaction and the curing step.

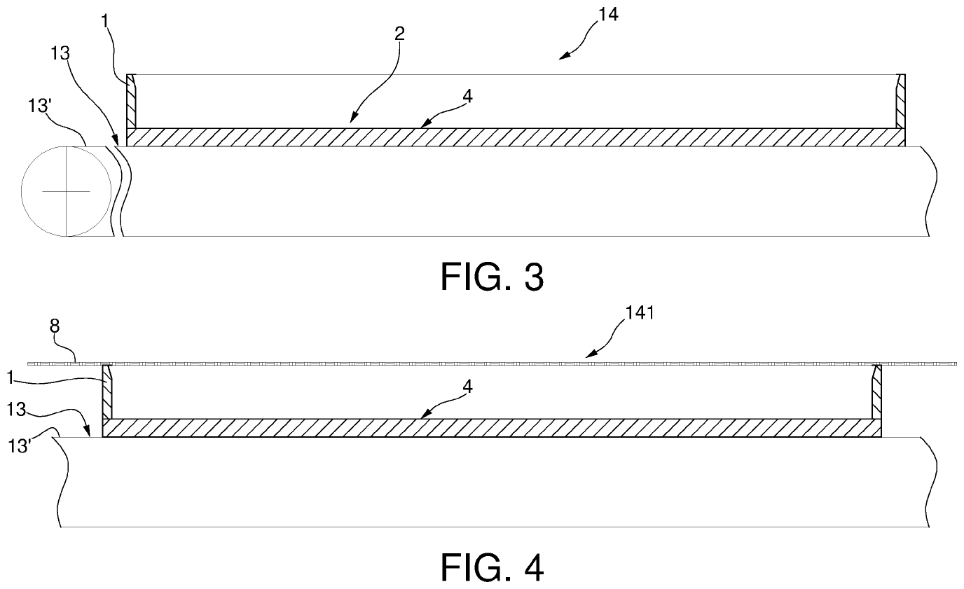

The plant 12 has a loading station 14, along which the at least one mould 1 is placed on the movement means 13 (FIG. 3), a lower protection sheet 8 and the mixture 3 are inserted.

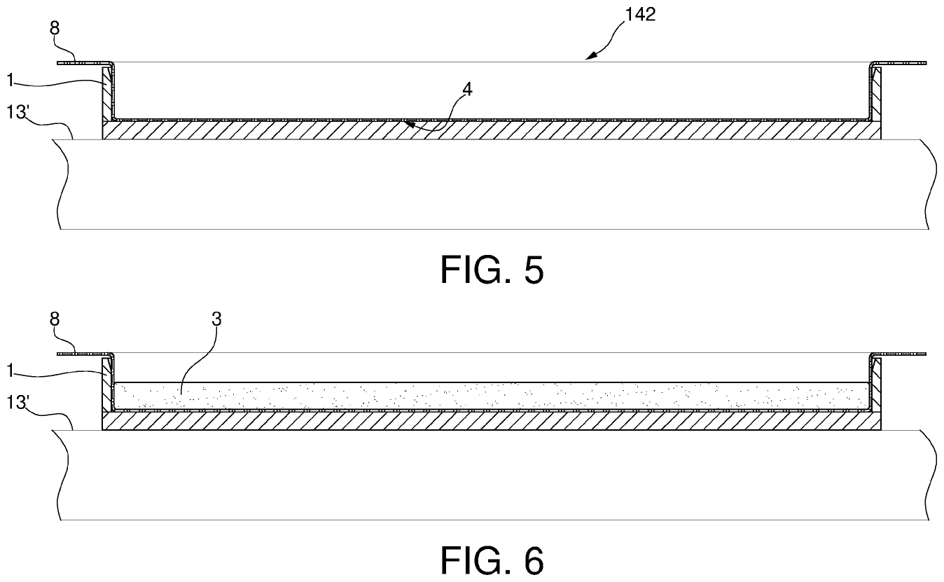

In a lower sheet insertion station 141, a first sheet 8 is placed on the mould 1 (FIG. 4), then in a die-cutting station 142 (FIG. 5) it is shaped and laid above the flat bottom 4 of the mould 1 and a layer of mixture 3 is distributed on the first sheet 8 (FIG. 6).

A further station (not shown) may also be provided for inserting additional material to the mixture 3 to obtain particular aesthetic effects.

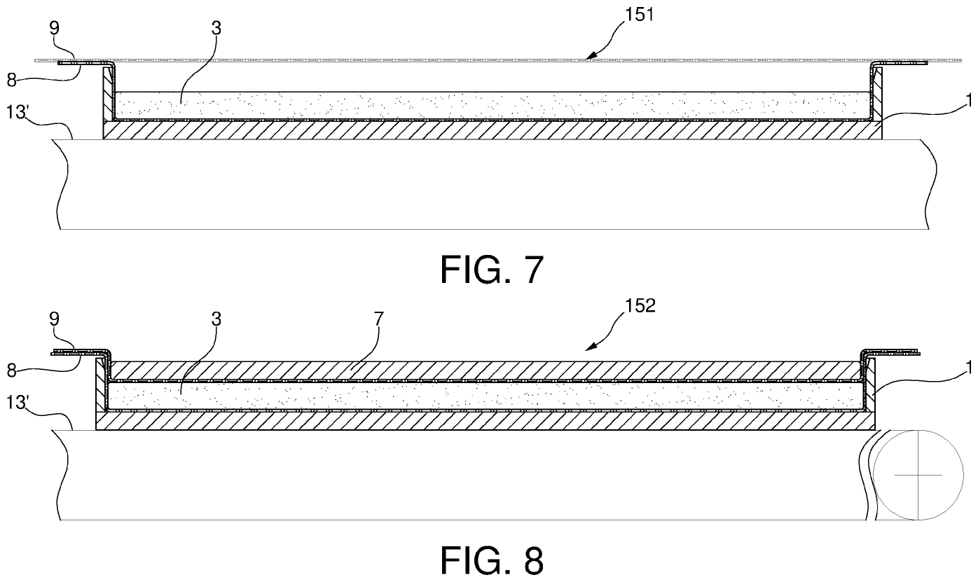

The plant 12 then has a closing station 15 of the mould 1 comprising an upper sheet insertion station 151 in which the second sheet 9 is positioned above the mixture layer 3 (FIG. 7) and a cover insertion station 152 in which is inserted the closing element 7 (FIG. 8), in fact creating a sandwich of dough of grits and/or sands of stone material bonded with resin between two protective sheets 8, 9 contained in turn inside a rigid support—flat bottom 4, perimeter framework 5 and closing element 7.

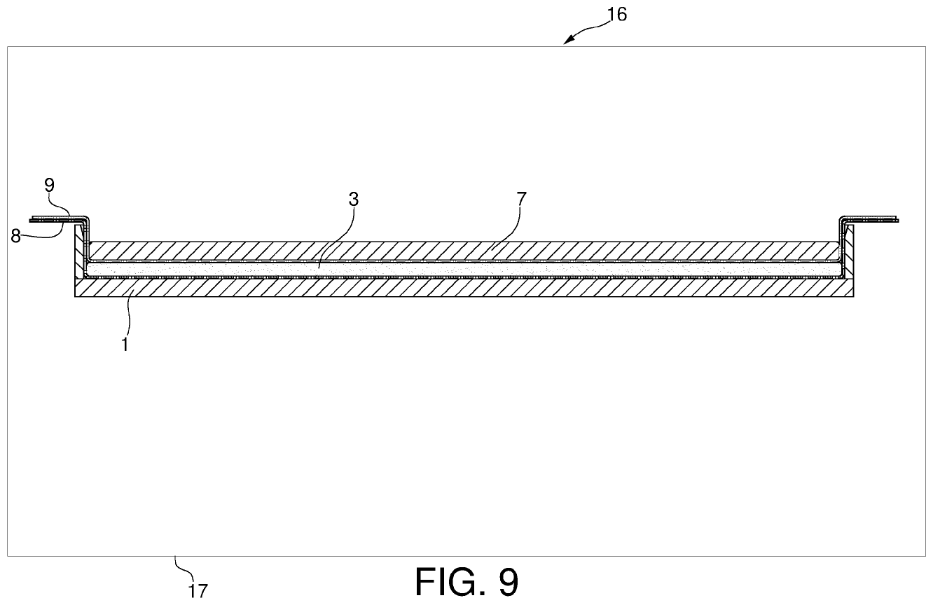

The plant 12 comprises a compaction station 16 comprising a press 17 (FIG. 9) for vacuum vibro-compaction of the mixture 3 contained in the mould 1. The press 17 is configured to house the mould 1 inside a pressing chamber.

The press 17 for vacuum vibro-compaction of the mixture 3 is not the object of the present invention and therefore will not be described in detail.

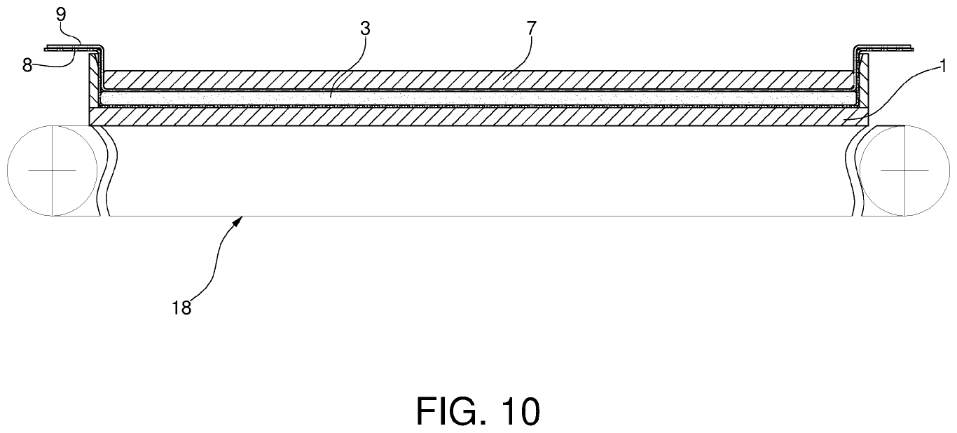

The plant 12 comprises second movement means 18 located downstream of the compaction station 16 (FIG. 10), on which the mould 1 has to be placed leaving press 17 itself and to transfer the mould 1 to other production steps.

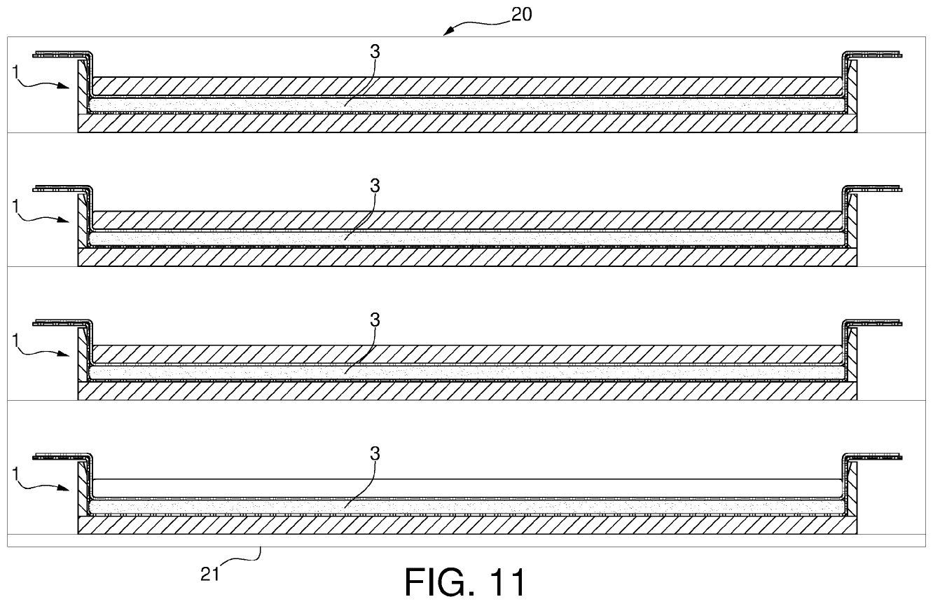

The plant 12 comprises a curing station 20 comprising at least one drying/curing apparatus 21 (FIG. 11), of a type known in the field, inside which the resin present in the mixture 3 is reacted to determine its curing and then obtain a slab of compact and cured material.

The second movement means 18 feed the mould 1 with the mixture 3 compacted towards the curing station 20 in which the mixture 3 becomes a cured slab 31.

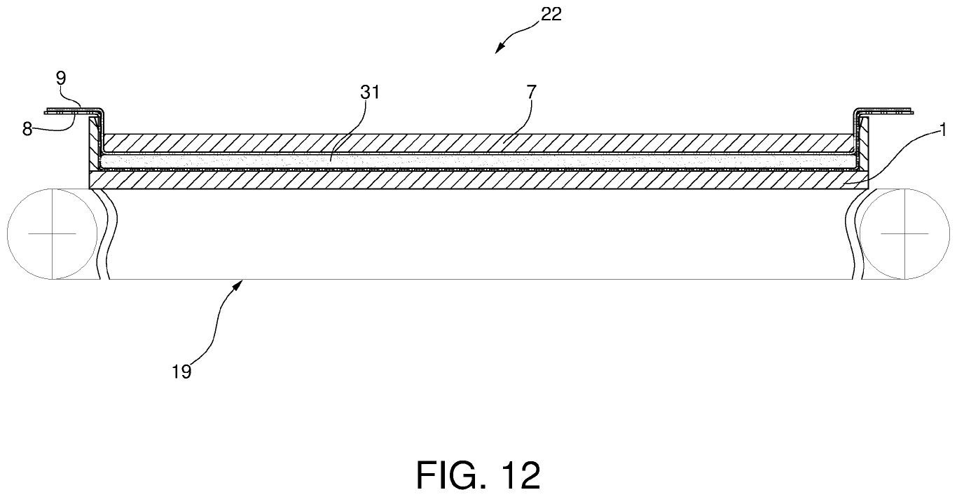

The plant 12 can therefore comprise a discharge station 22 (FIG. 12) along which the moulds 1 are positioned with the cured slabs 31 leaving the curing station 20, and therefore the moulds 1 with the slabs 31 are transferred through third movement means 19 (FIG. 12) towards a station for extracting the slabs and a station for cooling to ambient temperature, in which the slabs are suitably moved and positioned vertically in a deposit rack (not shown).

In the versions of the present invention which will follow in the description, the components or production stations corresponding to those described for the previous version will maintain the same numbering, while the modified components or production stations will be indicated with the same reference numbers increased by one hundred.

In the version shown in FIGS. 13-24, the mould 1 comprises fixed side walls 6 with respect to the flat bottom 4 as in the previous version, while the operating sequence is characterized by a step of curing the mixture 3 without the mould.

FIG. 13 schematically illustrates a plant 112 for the production of slabs obtained from grits and/or sands in stone material bonded with resins that can be cured when subjected to heat or to a suitable catalyst as in the case of the above illustrated plant 12.

The plant 112 comprises movement means 13, 18, 19, 23 on which at least one mould 1 is arranged, suitable for supporting and moving the latter along the various stations of the plant 112 itself.

Also in this version of plant 112, by way of example, the movement means 13, 18, 19, 23 can comprise conveyor belts 13′ (FIGS. 13-24), or roller conveyors, or even other equivalent means suitable to support and transport the mould 1 or a slab along various stations of the plant 112 itself.

The plant 112 comprises a loading station 14 and a closing station 15 of the mould 1, substantially similar to the above illustrated version of the plant 12.

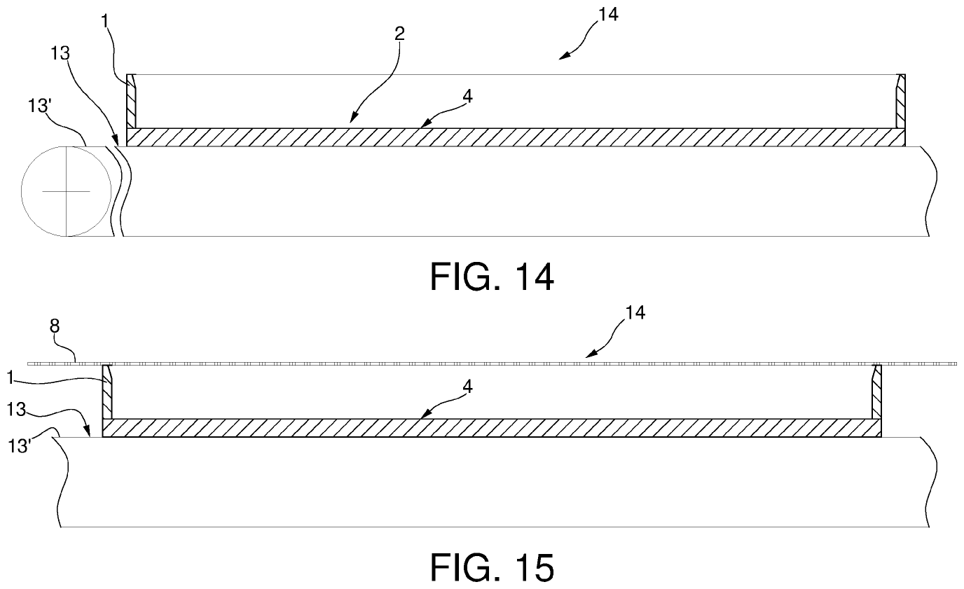

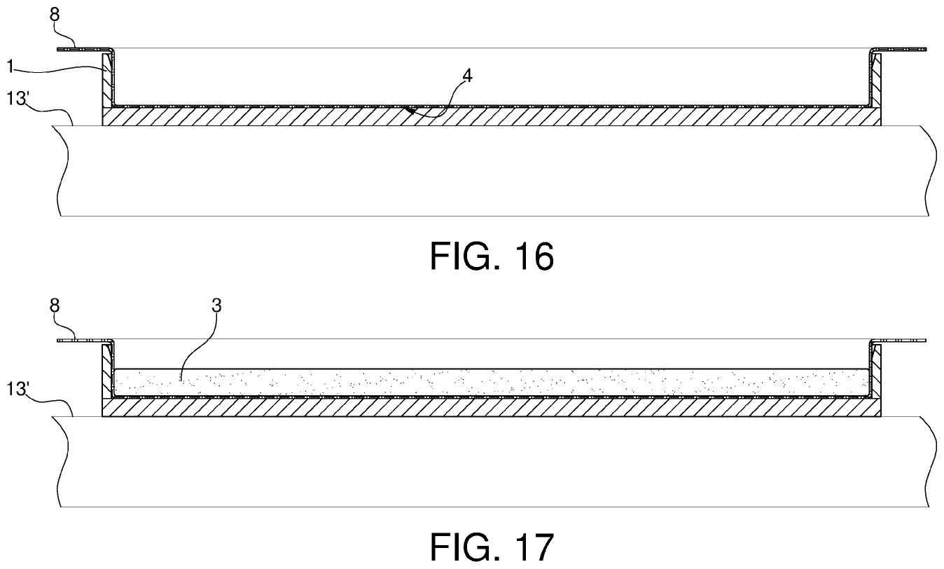

In detail, in the loading station 14 the at least one mould 1 is placed on the movement means 13 (FIG. 14); a first sheet 8 is then laid and punched above the flat bottom 4 of the mould 1 (FIGS. 15 and 16) and, in turn, a layer of mixture 3 is distributed on the first sheet 8 (FIG. 17).

As in the preceding version, a further station (not shown) may be provided for inserting additional material to the mixture 3 to obtain particular aesthetic effects.

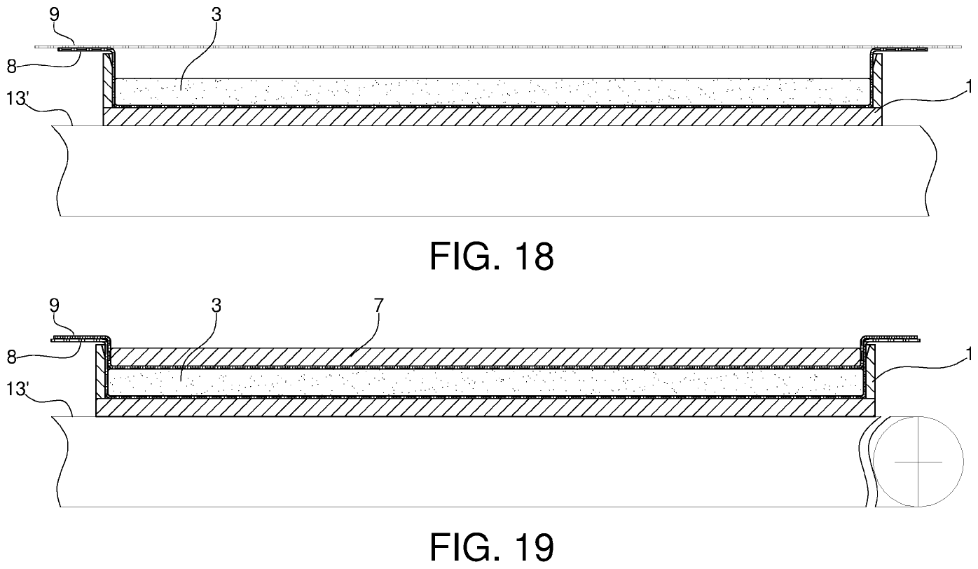

In the closing station 15 of the mould 1 the second sheet 9 is positioned above the layer of mixture 3 (FIG. 18) and the closing element 7 is inserted (FIG. 19).

As in the plant of the previous version, it is obtained a sandwich of dough of grits and/or sands of stone material bonded with resin between two protective sheets 8, 9 contained in turn inside a rigid support—flat bottom 4, perimeter framework 5 and closing element 7.

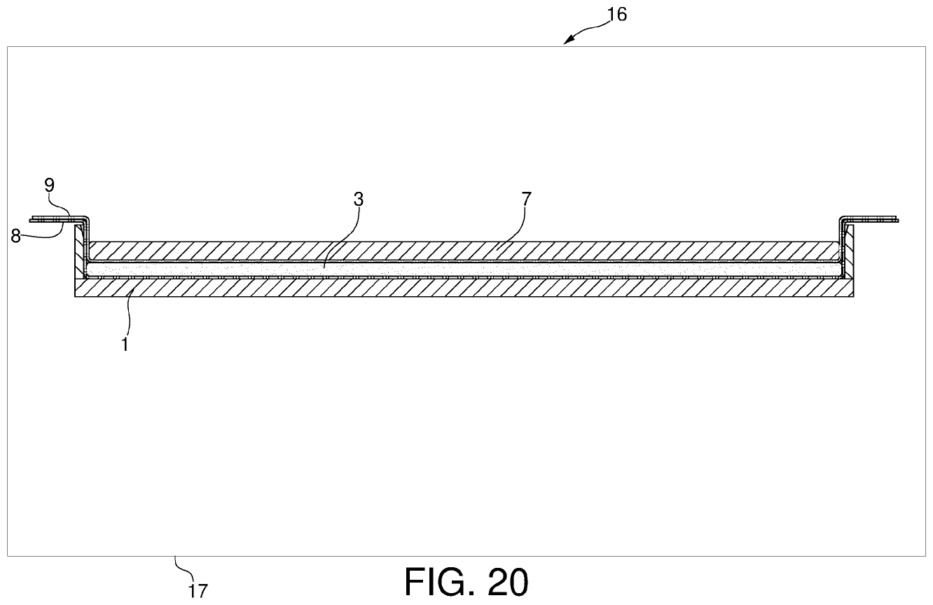

The plant 112 further comprises a compaction station 16 comprising a press 17 (FIG. 20) for vacuum vibro-compaction of the mixture 3 contained in the mould 1.

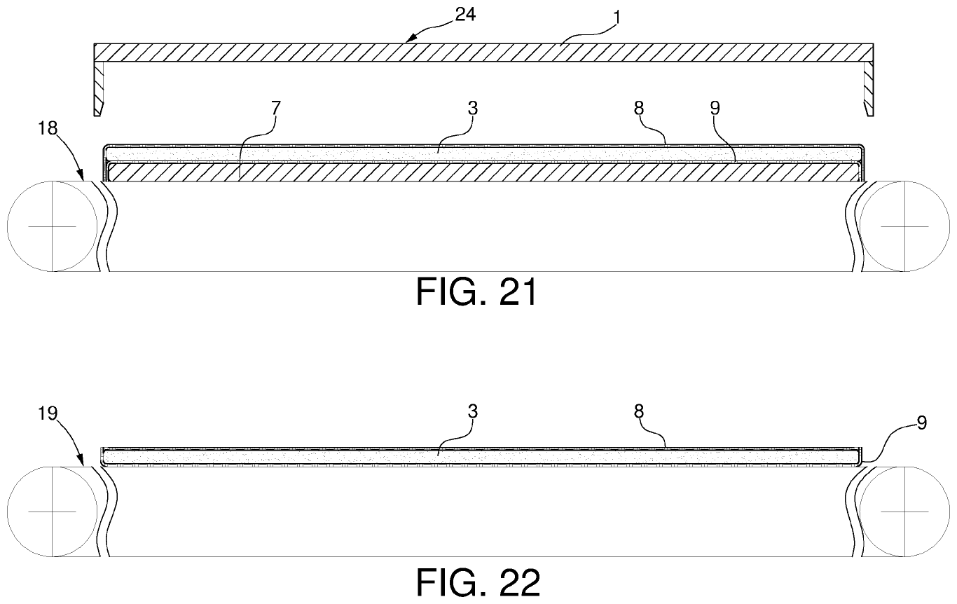

Unlike the plant of the previous version illustrated in FIGS. 2-12, the plant 112 comprises a mould overturning station 24 provided with second movement means 18 positioned downstream of the compaction station 16 (FIG. 21).

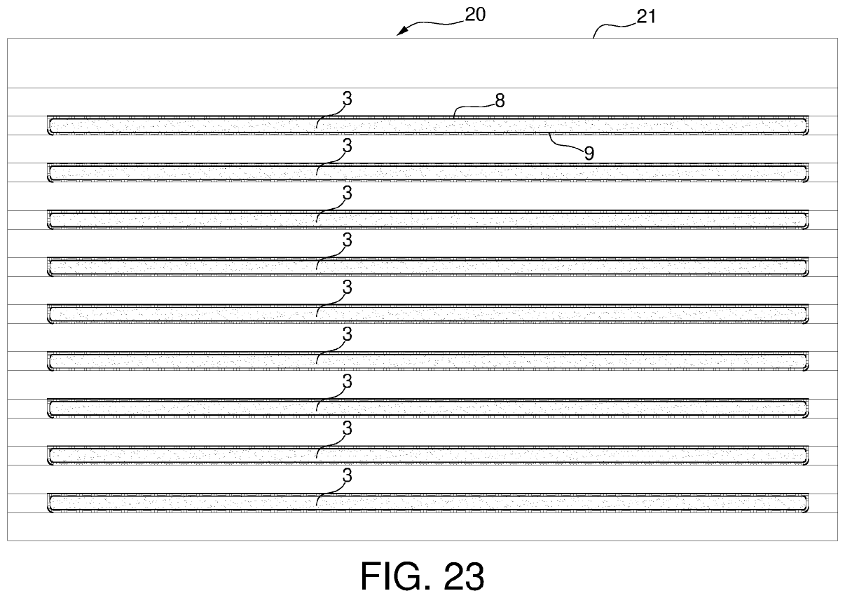

In the mould overturning station 24, the mould 1 is overturned and the mixture 3, with the two protective sheets 8, 9, is extracted from the compartment 2 of the mould 1 and is sent starting from an insertion station 25 (FIG. 22) of the mixture 3, by means of third movement means 19, towards a curing station 20 comprising at least one drying/curing apparatus 21 (FIG. 23).

It should be noted that the mixture 3 is cured in the drying/curing apparatus 21 wrapped only between the two protective sheets 8, 9, while the drying/curing apparatus 21 is completely similar to that of the previous version, but with the possibility of loading a greater number of groups formed by the mixture 3 wrapped in the sheets 8, 9, due to their smaller bulk.

Therefore, after the extraction of the mixture 3 from the mould 1, which took place in the mould overturning station 24, it is possible to recover the moulds 1 and the closing elements 7 thereof which are sent, via transfer means (not shown), to the respective stations of relevance for later use.

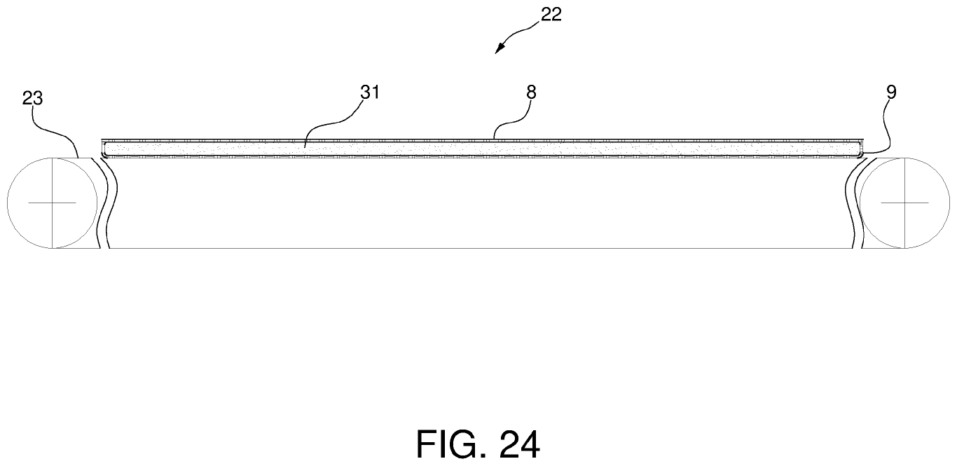

Finally, the cured mixture 3, which became a slab 31, is sent, through fourth movement means 23 (FIG. 24), to a station for cooling at ambient temperature, wherein the slab is suitably moved and positioned vertically in a storage rack (not shown).

Also, in the version illustrated in FIGS. 25-36, a mould 101 comprises fixed side walls with respect to the flat bottom 4 as in the previous version but has an extraction device which allows the mixture 3 to be extracted before the curing step. Consequently, also the operative sequence relating to this version is characterized by a step of curing the mixture 3 without the mould 101.

FIG. 25 schematically illustrates a plant 212 for the production of slabs obtained from grits and/or sands in stone material bonded with resins that can be cured when subjected to heat or to a suitable catalyst as in the previously illustrated cases.

This version of the plant 212 comprises movement means 13, 118, 119, 23 on which to place at least one mould 101 or the mixture 3, suitable for supporting and moving the latter along the various stations of the plant 212 itself, the aforementioned means may comprise conveyor belts 13′ (FIGS. 25-36), or roller conveyors, or even other equivalent means able to support and transport the mould 101 or a slab along the various stations of the plant 212 itself.

The mould 101 differs from the previous versions with respect to the methods of extracting the compacted mixture 3 inside the mould 101 itself, as better described below.

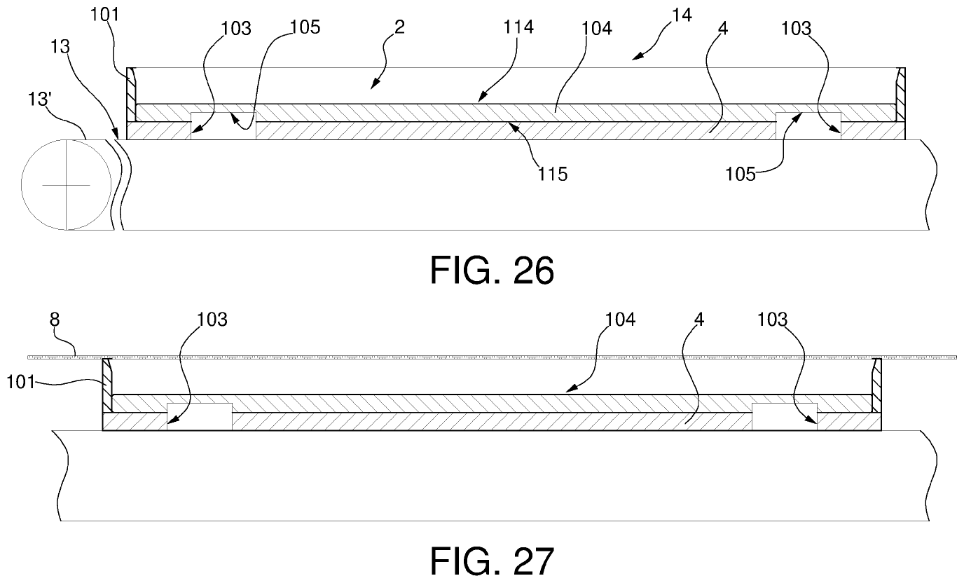

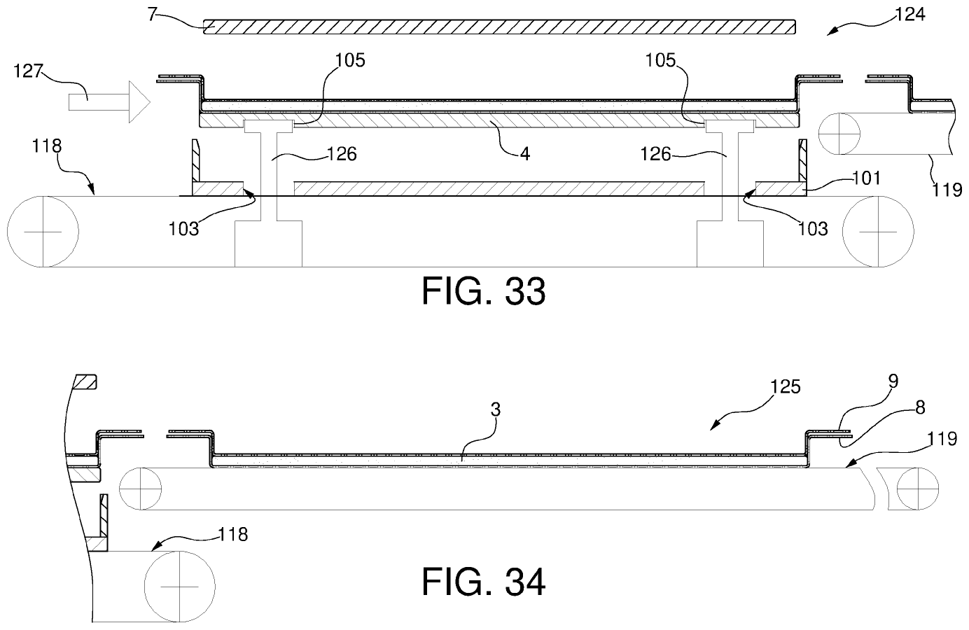

The mould 101 also defines a compartment 2 inside which the mixture 3 is distributed and comprises a flat bottom 4 delimited by a perimeter framework 5, which comprises vertical walls 6. The mould 101, see in particular FIGS. 26 and 33, also has an extractor device 102 comprising through openings 103 arranged on the flat bottom 4 and a support plate 104 vertically movable which can be provided with seats 105 and extractor members 126.

Moreover, the plate 104 can be rested on the flat bottom 4 by means of abutments (not shown) of adjustable height which allow the plate 104 to be positioned at different height so as to obtain greater or smaller thicknesses of the mixture 3.

The support plate 104 has a plan development equal to or slightly smaller than the area of the bottom 4 delimited between the perimeter framework 5.

The support plate 104 has an upper surface 114 and a lower surface 115 parallel to each other. The upper surface 114 and the lower surface 115 are flat to favour the flatness of the slab to be formed inside the mould 101.

As mentioned, the flat bottom 4 comprises multiple through openings 103 which are selectively engageable by the extractor members 126 to allow the lifting and removal of the support plate 104 from the compartment 2 of the mould 101.

The support plate 104, in fact, faces the through openings 103.

As stated, the support plate 104 can have a plurality of seats 105, each at a through opening 103.

In particular, each seat 105 can face through a corresponding through opening 103 to be engageable by a respective extractor member 126.

According to a version of the present invention, each seat 105 is made blind by way of the thickness of the support plate 104 and acts as a firm abutment for a corresponding extractor member 126.

The presence of a plurality of seats 105 can favour the stable and safe extraction of the support plate 104 from the mould 101.

The plant 212 of FIGS. 25-36 comprises a loading station 14 and a closing station 15 of the mould 101, substantially similar to the above illustrated version of the plant 12, 112.

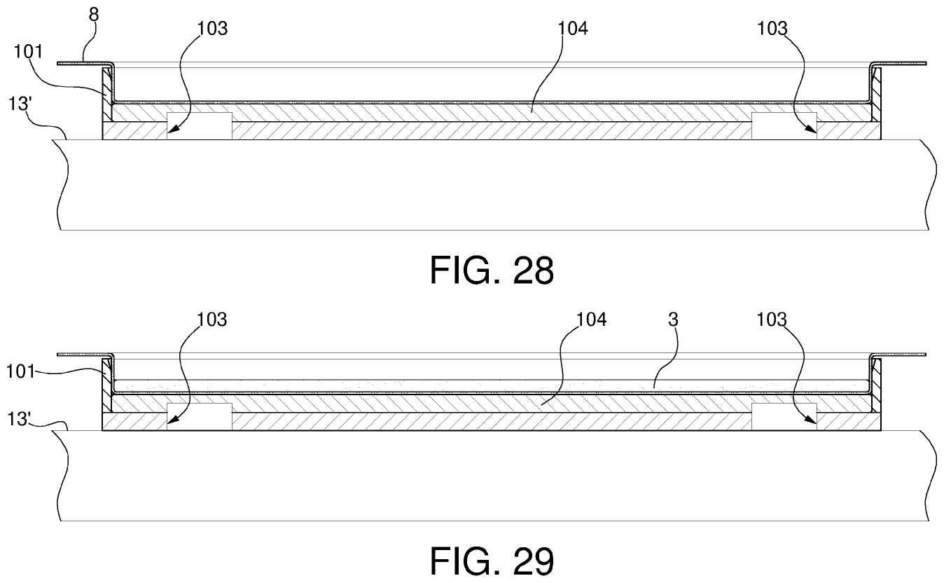

In the loading station 14 the at least one mould 101 is placed on the movement means 13 (FIG. 26); a first sheet 8 is then laid and punched above the plate 104 of the mould 101 (FIGS. 27 and 28) and, in turn, a layer of mixture 3 is distributed on the first sheet 8 (FIG. 29).

As in the preceding versions, a further station (not shown) may be provided for inserting additional material to the mixture 3 to obtain particular aesthetic effects.

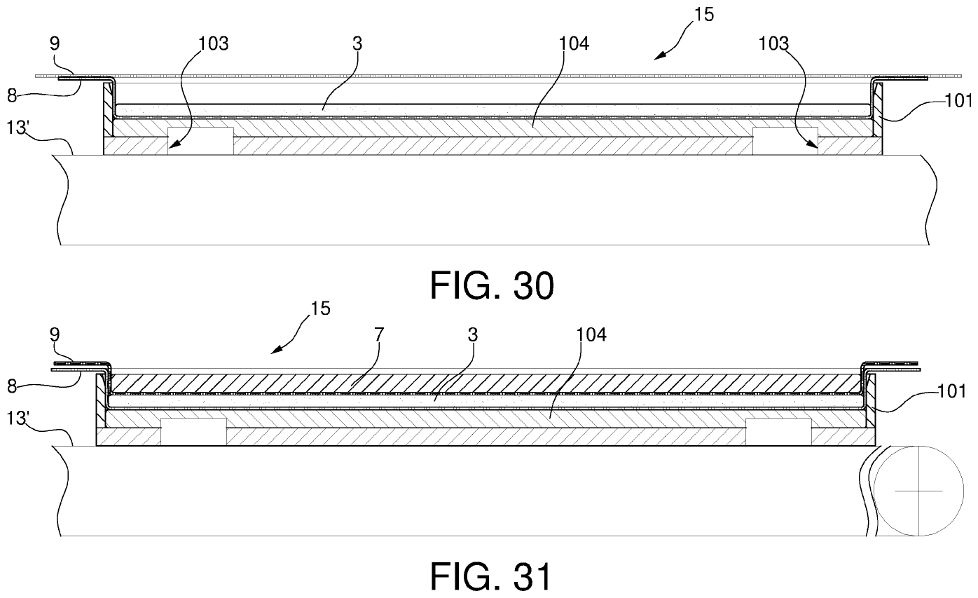

In the closing station 15 of the mould 1 the second sheet 9 is positioned above the layer of mixture 3 (FIG. 30) and the closing element 7 is inserted (FIG. 31).

It is obtained a sandwich of dough of grits and/or sands of stone material bonded with resin between two protective sheets 8, 9 contained in turn inside a rigid support support plate 104 and flat bottom 4, perimeter framework 5 and closing element 7.

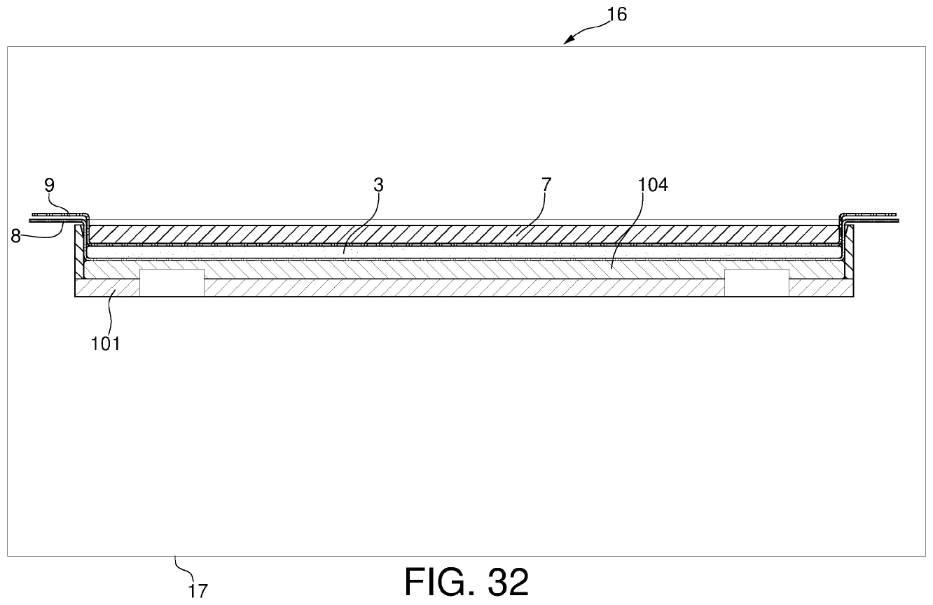

The plant 212 further comprises a compaction station 16 comprising a press 17 (FIG. 32) for vacuum vibro-compaction of the mixture 3 contained in the mould 101.

FIG. 33 shows the station 124 for extracting the mixture 3 compacted and wrapped between the two protective sheets 8, 9.

The extraction station 124 comprises second movement means 118 located downstream of the compaction station 16, of the extractor members 126 which pass through the through openings 103 of the mould 101 and can be inserted in the seats 105 of the support plate 104, and of the movement means 127 to move the mixture 3 with the two protection sheets 8, 9 from the extraction station 124 to the insertion station 125.

The mould 101 arriving at the extraction station 124 through the second movement means 118 is positioned above the extractor members 126.

First the closing element 7 is lifted by means of gripping means (not shown), then the aforesaid extractor members 126 are raised, pass through the through openings 103 of the flat bottom 4 and are inserted in the seats 105 of the support plate 104, then they raise the plate 104 to the same height as the third movement means 119 of the insertion station 125.

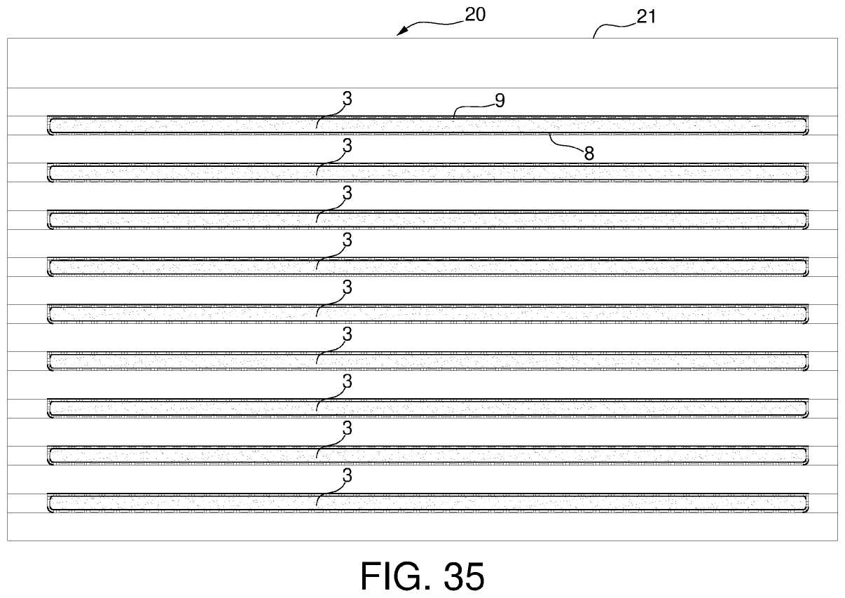

The movement means 127 then move the mixture 3 with the two protective sheets 8, 9 from the bottom plate 104 onto the third movement means 119, which in turn feed a curing station 20 comprising at least one drying/curing apparatus 21 (FIG. 35).

After the extraction of the mixture 3 from the mould 101, which took place in the extraction station 124, it is possible to recover the moulds 101 which are sent, via transfer means (not shown), to the respective stations of relevance. As for the previous version, the mixture 3 is cured in the drying/curing apparatus 21 wrapped only between the two protective sheets 8, 9.

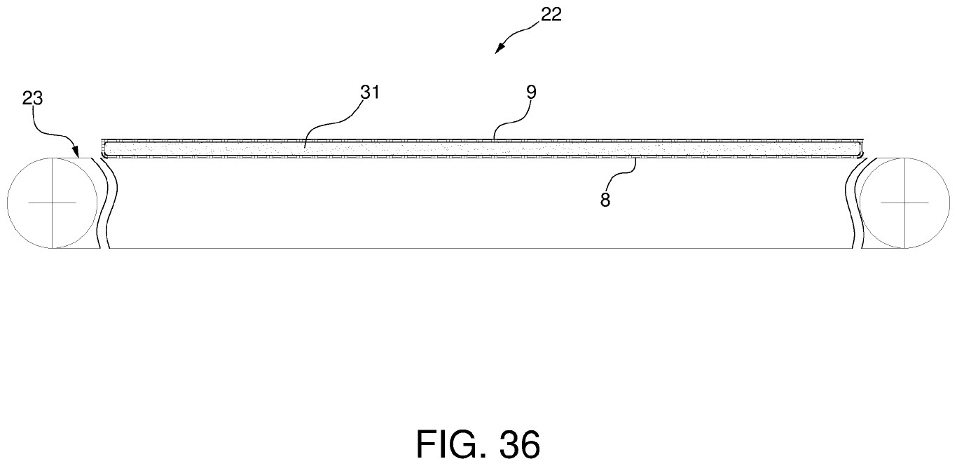

Finally, the cured mixture 3, which became a slab 31, is sent, through fourth movement means 23 (FIG. 36), towards a station for extracting the slabs and a station for cooling to ambient temperature, wherein the slabs are suitably moved and positioned vertically in a storage rack (not shown).

In the version shown in FIGS. 37-49, a mould 201 has at least one of the side walls 6 which can be movably connected to the flat bottom 4 to selectively free at least one passage for accessing the inside the mould 201 and favour the extraction of the mixture 3 which is compacted and cured on the inside. According to a version of the present invention, the side walls 6 are operatively connected to the flat bottom 4 through hinge connections not shown in detail in the figures.

At least one of the individual side walls 6 can be tilted independently of the other side walls 6, with respect to the flat bottom 4 between a horizontal position, in which the single side wall 6 frees an access passage inside the mould 201 and a vertical position in which the single side wall 6 defines a containment side for the mixture to be retained inside the mould 201.

By tilting at least one side wall 6, in fact, a passage is freed to allow the extraction of the layer of material formed inside the mould 1 itself.

According to a further version of the invention, not shown in the accompanying figures, at least one of the side walls 6 can be connected to the flat bottom 4 by means of a removable connection, such as a joint or the like, for the same purposes described 20 relating with the previous version.

According to a further version of the invention, not shown in the attached figures, the mould 1 can comprise at least one mechanism for opening and/or tilting at least one of the side walls 6. By way of example, such a mechanism can be of the automatic, mechanical and/or electromechanical and/or servo-hydraulic and/or servo-pneumatic type.

The plant 312 of FIGS. 37-49 comprises a loading station 14 and a closing station 15 of the mould 201.

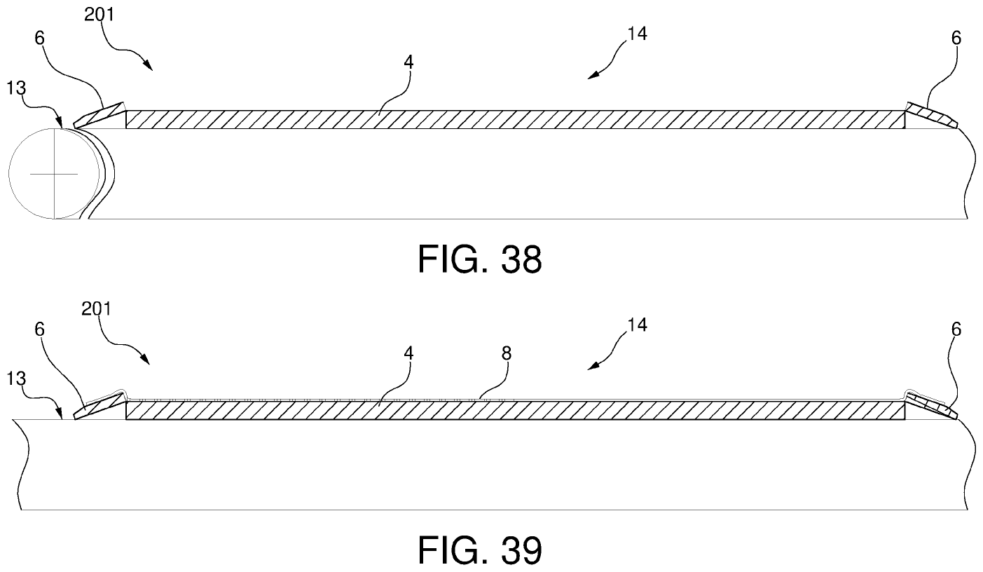

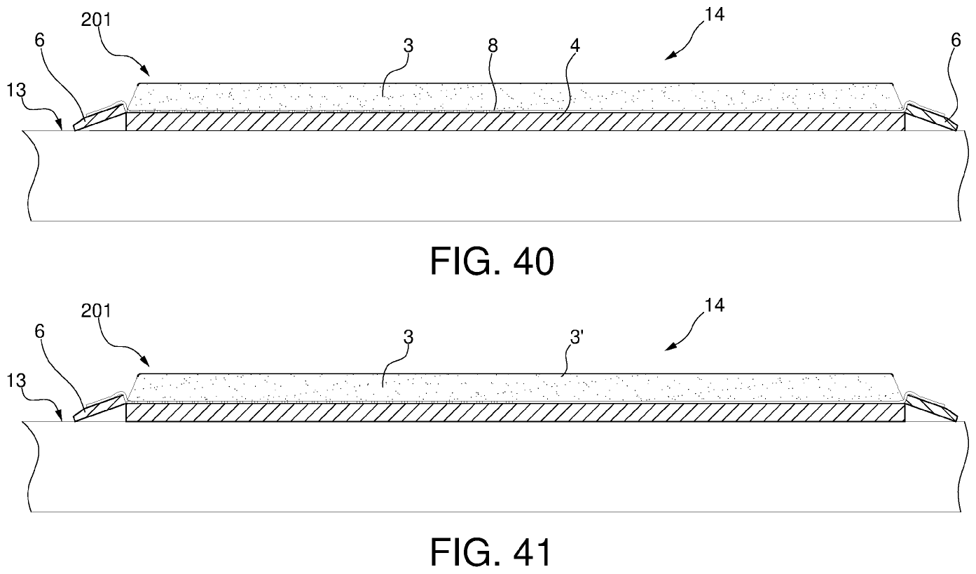

The at least one mould 201 is arranged on the movement means 13 with at least one side wall 6 open and resting on the movement means 13 (FIG. 38); a first sheet 8 is then laid and punched at the top on the bottom 4 of the mould 201 (FIG. 39) and, in turn, a layer of mixture 3 is distributed on the first sheet 8 (FIG. 40).

As in the preceding versions, a further station (FIG. 41) may be provided for inserting additional material 3′ to the mixture 3 to obtain particular aesthetic effects.

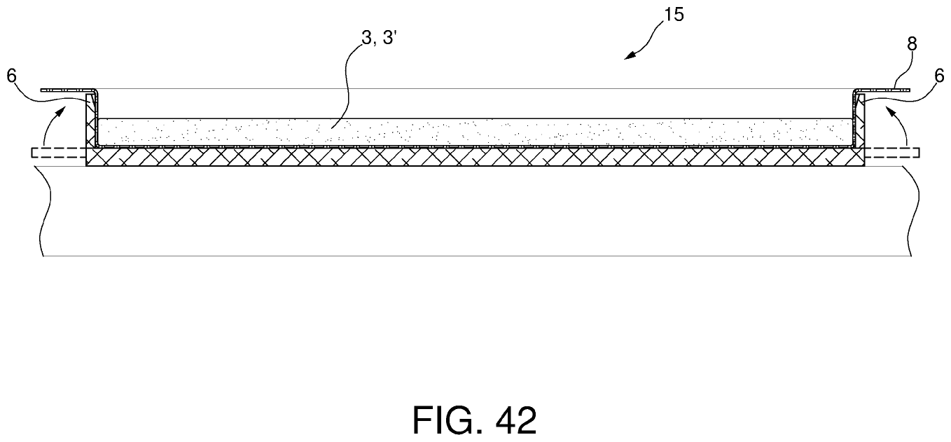

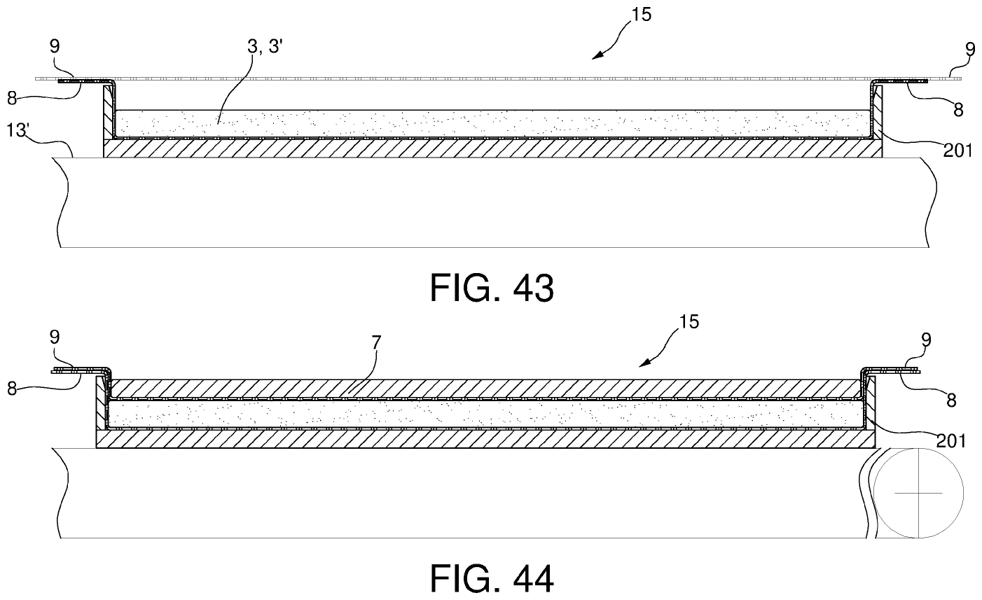

In the closing station 15, the side walls 6 are closed arranging them in vertical position (FIG. 42) and the second sheet 9 is positioned above the layer of mixture 3, 3′ (FIG. 43) and the closing element 7 is inserted (FIG. 44).

It is obtained a sandwich of dough of grits and/or sands of stone material bonded with resin between two protective sheets 8, 9 contained in turn inside a rigid support—flat bottom 4, perimeter framework 5 and closing element 7.

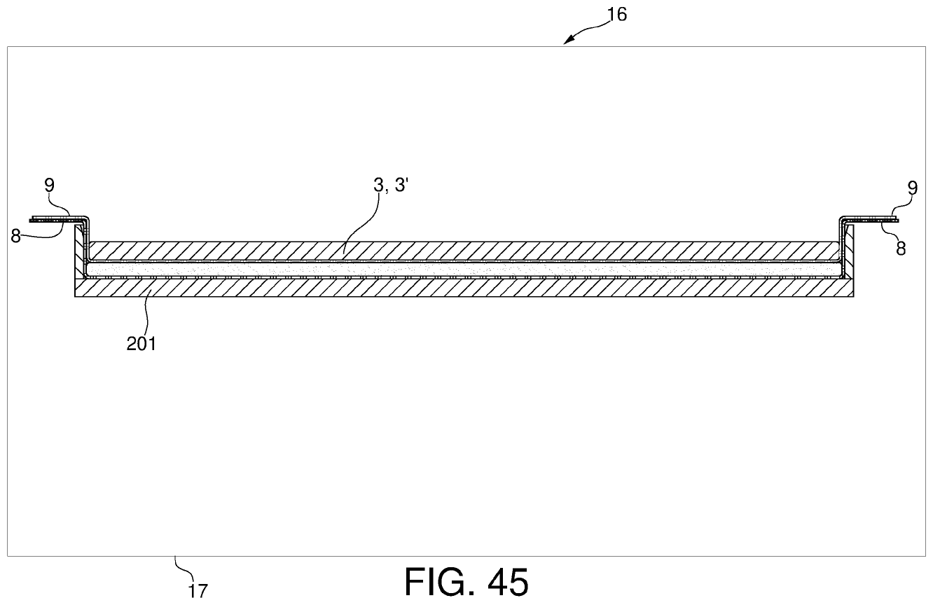

The plant 312 further comprises a compaction station 16 comprising a press 17 (FIG. 45) for vacuum vibro-compaction of the mixture 3 contained in the mould 201.

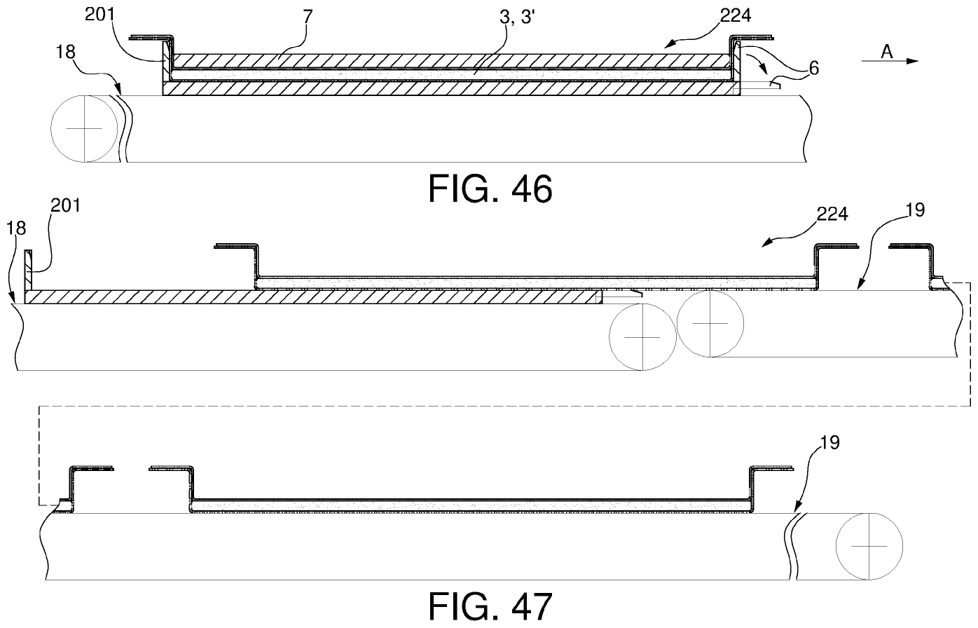

FIGS. 46, 47 show the station 224 for extracting the mixture 3 compacted and wrapped between the two protective sheets 8, 9.

The extraction station 224 comprises second movement means 18 located downstream of the compaction station 16, of the extraction means (not shown) of the mixture 3, 3′ wrapped between the two protective sheets 8, 9 and the third movement means 19.

In the extraction station 224, the closing element 7 is lifted by means of lifting means of the closing element 7, and at least one side wall 6 is tilted by means of tilting means of the side walls 6 of the mould 201, in the specific case the front wall 6 is tilted according to the advancement direction A of the mould 201 on the second movement means 18 (FIG. 46).

The extraction means extract the mixture 3, 3′, wrapped between the two protective sheets 8, 9, according to the advancement direction A of the mould 201 and position it on the third movement means 19, which in turn send the mixture 3, 3′ towards the drying/curing apparatus 21 (FIG. 47).

After the extraction of the mixture 3, 3′ from the mould 201, which took place in the extraction station 224, it is possible to recover the moulds 201 which are sent, via transfer means (not shown), to the respective stations of relevance.

As for the previous version, the mixture 3 is cured in the drying/curing apparatus 21 wrapped only between the two protective sheets 8, 9.

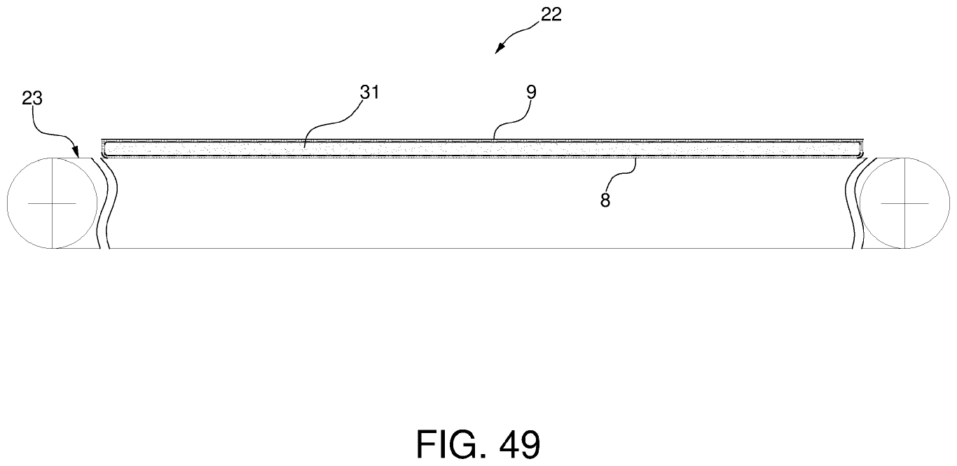

Finally, the cured mixture 3, 3′ which became a slab 31 is sent, through fourth movement means 23 (FIG. 49), towards a station for extracting the slabs and a station for cooling to ambient temperature, wherein the slabs are suitably moved and positioned vertically in a storage rack (not shown).

Among the advantages of the present invention it is possible to mention that, at the time of leaving the press, all the surfaces of the mixture 3 compacted inside the mould 1, 101, 201 are flat and smooth, without burrs.

As said, the rigidity of the mould 1, 101, 201 allows to obtain a compacted layer of mixture 3 which has perimeter surfaces, upper and lower geometrically free from defects of flatness or burrs.

In practice, by means of the mould 1, 101, 201 it is possible to obtain slabs of compacted material without surface shrinkages, in the context of a solution capable of optimizing production costs with respect to conventional compact sheet forming plants which, after the forming step, provide numerous and costly processes to recover the surface characteristics of the slab itself.

The above described mould 1, 101, 201 and the respective plants 12, 112, 212, 312 are susceptible to several modifications and variations within the scope of protection of the following claims.

1. A mould for the production of slabs in granular material and/or grits and/or sands with curing resins, the mould comprising:
a flat bottom;
a perimeter framework operatively connected to said flat bottom, wherein
said perimeter framework comprises a plurality of side walls,
said flat bottom and said perimetric framework delimiting a compartment for forming said slab,
at least one of said side walls is connected tiltable or removable with respect to said flat bottom to facilitate the extraction of said slab formed in said mould or that said flat bottom has at least one through opening selectively engageable by extractor members to allow the extraction of said slab from said mould or that the side walls are rigidly connected to said flat bottom.

2. The mould according to claim 1, further comprising:
a closing element which can be inserted into said compartment to delimit above said compartment.

3. The mould according to claim 1, further comprising:
a first protective sheet, which can be positioned above said bottom and to cover the inner surface of said side walls on which the layer of material to be compacted and cured to obtain said slab is loaded.

4. The mould according to claim 3, further comprising:
a second protective sheet, which can be positioned above said layer of material to be compacted and cured to obtain said sheet.

5. The mould according to claim 4, wherein
said first and/or second protective sheet can be made with one or more materials chosen from the group comprising: simple paper, paper with coatings having anti-adherent properties, simple cardboard, cardboard with a coating having anti-adherent properties, plastic films with non-adherent properties, water-soluble films.

6. The mould according to claim 1, wherein
each of said side walls has a flaring at an upper end of said side walls, and
said flaring is made at an inner surface in use of each of said side walls.

7. The mould according to claim 1, further comprising
a support plate which can be positioned in abutment with said flat bottom.

8. The mould according to claim 7, wherein
said support plate comprises at least one seat at a respective one of said at least one through opening, and
said seat is selectively engageable by a respective one of said extractor members.

9. A plant for the production of compact slabs obtained by compacting and curing a mixture of grits and/or sands of stone material bonded with a resin capable of curing, comprising movement means of said mould according to claim 1, at least one loading station, a closing station of said mould downstream of said loading station, a compaction station downstream of said loading station and at least one curing station, downstream of said compaction station.

10. The plant according to claim 9, further comprising:
second movement means of said mould downstream of said compaction station and third movement means of said mould downstream of said second movement means, wherein
said third movement means are suitable for moving a layer of material previously compacted in said compaction station enclosed between said first sheet and said second sheet, towards said curing station.

11. The plant according to claim 9, further comprising:
a mould overturning station, arranged upstream of at least one curing station, suitable for extracting said mixture from said mould wrapped between said first and said second protective sheet.

12. The plant according to claim 9, further comprising:
extractor members operatively connected to said second movement means to facilitate the extraction of said layer of compacted material enclosed between said first sheet and said second sheet on the outside of said mould.

13. The plant according to claim 9, further comprising:
an extraction station, arranged upstream of at least one curing station, suitable for extracting said mixture from said mould wrapped between said first and said second protective sheet, said extraction station comprising means for tilting the side walls of the mould and means for extracting the mixture wound between the two sheets suitable for extracting said mixture according to the advancement direction of said mould along said plant.

14. A method for forming a uniform slab of compact and cured material, the method comprising:
providing a mould according to claim 1; arranging a first protective sheet on said flat bottom;
providing a layer of a mixture of granular material and/or sand of stone material bonded with resin suitable to cure on said first sheet;
providing a second sheet above said uniform layer of mixture;
providing a closing element by inserting it at the top into said mould;
subjecting said mould to vacuum vibro-compaction until compacting said layer of material inside said mould; and
subjecting said layer of compacted material to a curing process to allow the curing of said resin comprised in said material.

15. The method for forming a uniform layer of compact and cured material according to claim 14, further comprising:
extracting said compacted mixture interposed between said first sheet and said second sheet from said mould.

16. The method for forming a uniform layer of compact and cured material according to claim 14, wherein
said extracting said layer of compacted material comprises the step of tilting or removing at least one of said side walls of said mould to free a passage for the extraction of said layer of compacted material or the step of lifting said layer of compacted material outside said mould by the action of extractor members acting on a support plate provided inside said mould, on which said layer of compacted material is supported.

17. A method for forming a uniform slab of compact and cured material, the method comprising:
providing a mould;
arranging a first protective sheet on said flat bottom;
providing a layer of a mixture of granular material and/or sand of stone material bonded with resin suitable to cure on said first sheet;
providing a second sheet above said uniform layer of mixture;
providing a closing element by inserting it at the top into said mould;
subjecting said mould to vacuum vibro-compaction until compacting said layer of material inside said mould; and
subjecting said layer of compacted material to a curing process to allow the curing of said resin comprised in said material.

18. The method for forming a uniform layer of compact and cured material according to claim 17, further comprising:
extracting said compacted mixture interposed between said first sheet and said second sheet from said mould.

19. The method for forming a uniform layer of compact and cured material according to claim 17, wherein
said extracting said layer of compacted material comprises the step of tilting or removing at least one of said side walls of said mould to free a passage for the extraction of said layer of compacted material or the step of lifting said layer of compacted material outside said mould by the action of extractor members acting on a support plate provided inside said mould, on which said layer of compacted material is supported.
